(19) United States
(12) Patent Application Publication
(10) Pub. No.: US 2025/0166534 A1
(43) Pub. Date: May 22, 2025

(54) VISUAL AND AROMATIC DISPLAY DEVICE

(71) Applicant: ECONOCO CORPORATION, Hicksville, NY (US)

(72) Inventors: Matthew COMISKEY, East Patchogue, NY (US); Michael MENKE, Westbury, NY (US)

(21) Appl. No.: 18/955,556

(22) Filed: Nov. 21, 2024

Related U.S. Application Data
(60) Provisional application No. 63/601,553, filed on Nov. 21, 2023.

(51) Int. Cl. G09F 19/00; A47F 3/00; A47F 7/00; A47F 11/04; A47F 11/10

(52) U.S. Cl. CPC G09F 19/005; A47F 3/001; A47F 7/0078; A47F 11/10; A47F 11/04

(57) ABSTRACT

A display device and related method for visually displaying an aromatic product. The display device can include a container defining a cavity. The container includes a bottom wall, a front wall, a back wall opposing the front wall, a first side wall, and a second side wall opposing the first side wall. At least one of the first and second sidewalls include at least one slot, and a divider is shaped to fit within the slot to divide the cavity into a front section and a back section. A lid provides an airtight seal to the container and can include a lens and a selective air release vent.

### RELATED APPLICATIONS

The present application claims priority to U.S. Provisional Application Ser. No. 63/601,553 filed Nov. 21, 2023, which is hereby incorporated by reference in its entirety.

### FIELD OF THE INVENTION

The present invention relates to a display device. More specifically, the present invention is directed to a display device that securely positions an item to be displayed and selectively allows air within the container to escape.

### BACKGROUND OF THE DISCLOSURE

The use of display devices is well known in the art. For example, people have utilized display devices to allow potential customers to view an item, while also protecting the item from potential thieves. Display devices can commonly be seen in stores to display perfumes, jewelry, and other items. In addition, display devices have been used for visually displaying herbs while allowing a viewer to sample a scent without opening the display. For instance, legal cannabis dispensaries use display cases to educate, market and sell various strains of cannabis to consumers of cannabis. Some of these cases also allow a customer to smell the herb inside the case without fully opening the case or removing the herb.

While such displays exist, it would be advantageous for a display device to have the ability to control humidity, while securely concealing the humidity controller from view. Further, it would be advantageous to position an identifying transcription in the near vicinity of the sample, so a viewer can easily identify the sample or other branding without having to look away from the sample. Further still, it would be advantageous for a display device to allow the sample to be positioned in different positions within the display container.

### SUMMARY OF THE DISCLOSURE

Representative embodiments of the present invention include a container for displaying a sample. In one embodiment, the display device includes a container defining a cavity. The container comprises a bottom wall, a front wall, a back wall opposing the front wall, a first side wall, and a second side wall opposing the first side wall. At least one of the first and second sidewalls include at least one slot, and a divider is shaped to fit within the slot to divide the cavity into a front section and a back section. A lid provides an airtight seal to the container and can include a lens and a selective air release vent.

Another embodiment relates to a display device that includes a container defining a cavity. The container comprises a substantially circular bottom wall and a side wall extending upward from the bottom wall. The side wall contains at least one slot, and a divider is shaped to fit within the slot to divide the cavity into a front section and a back section. A lid provides an airtight seal to the container and may include a lens and a selective air release vent.

Yet another embodiment of the present application relates to a display device that includes a container defining a cavity. The container comprises a bottom wall, a front wall, a back wall opposing the front wall, a first side wall, and a second side wall opposing the first side wall. A divider is used to separate the cavity into a top portion and a bottom portion. At least one spear attaches to at least one of the front, back, first side, or second side walls and protrudes into the cavity.

### BRIEF DESCRIPTION OF THE DRAWINGS

FIG. 1A is a perspective view of a display device according to an exemplary embodiment.

FIG. 1B is a perspective view of a display device according to an exemplary embodiment.

FIG. 2 is a side view of the display device of FIG. 1A.

FIG. 3 is an exploded assembly view of the display device of FIGS. 1A and 2.

### DETAILED DESCRIPTION OF THE DRAWINGS

Referring generally to the figures, several embodiments of a display device are disclosed. The display devices disclosed herein allow for enhanced visual and aromatic experiences for a user inspecting a sample within the container. Further, the display devices disclosed within allow for efficient marketing and concealment of a humidity controlling device.

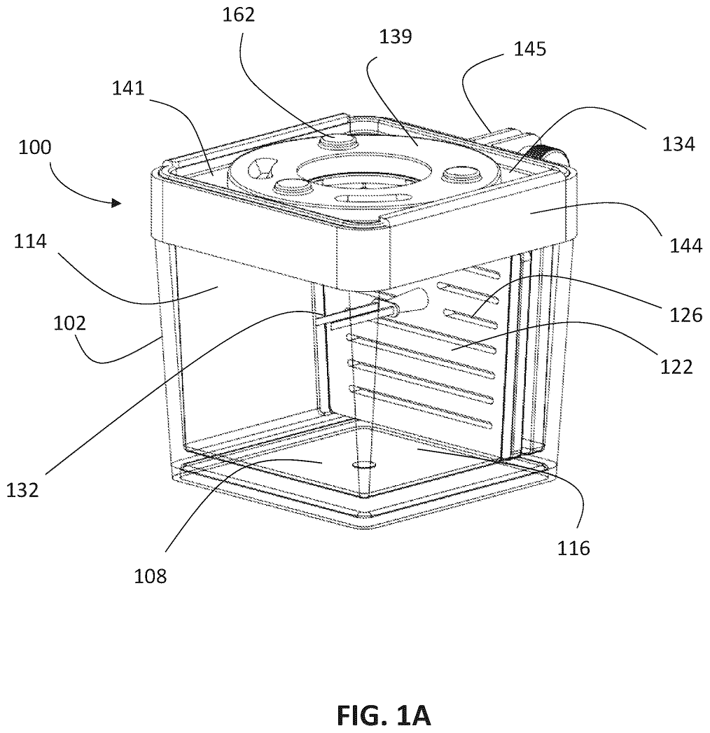

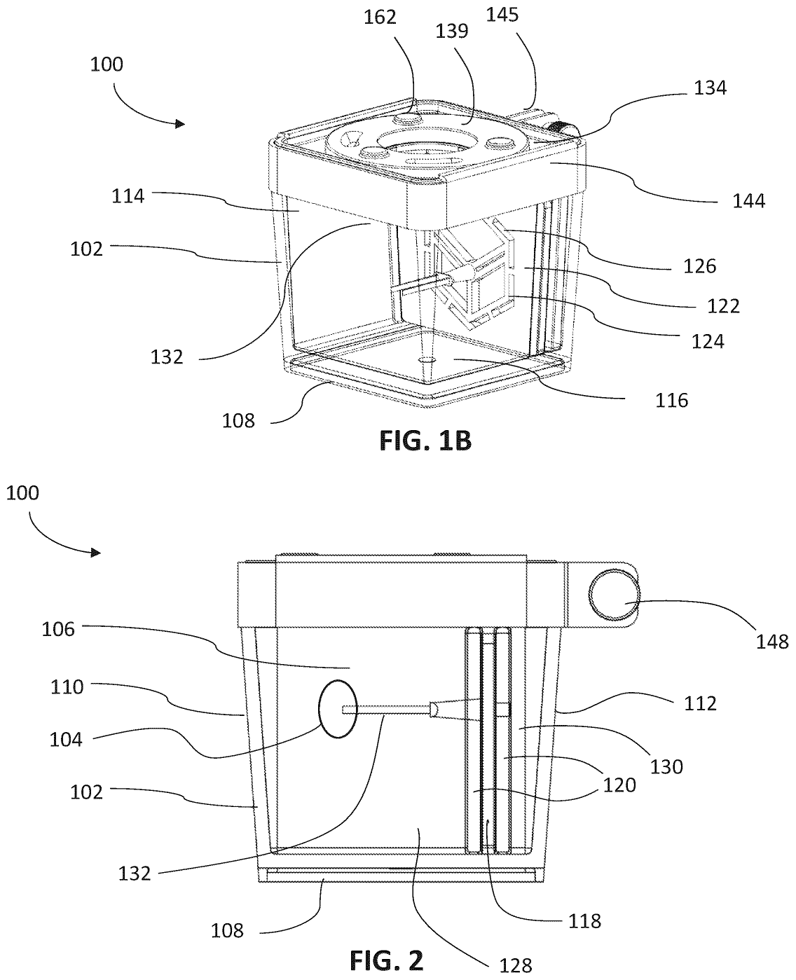

Referring to FIGS. 1A-3, a display device 100 is shown in various orientations according to an exemplary embodiment. FIGS. 1A-3 illustrate a display device 100 having a container 102. The container 102 comprises a bottom wall 108, a front wall 110, a back wall 112, a first side wall 114, and a second side wall 116. The walls define a cavity 106 within the container 102. According to an exemplary embodiment, the walls are made of a substantially transparent and food safe material. In another embodiment, one or more of the walls can utilize a mirrored surface. For example, a mirrored surf ace on the bottom wall 108 can allow a user to inspect the bottom of a sample 104 without having to turn the display device 100 upside down or raise the display device 100 above their head. In yet another embodiment, one or more of the walls are configured to receive a lens 154 to provide a magnified view of the sample 104.

In an exemplary embodiment, container 102 also comprises at least one slot 118. In some embodiments, the at least one slot 118 can be formed by slot protrusions 120. In other embodiments, the at least one slot 118 can be formed by a recessed portion in at least one of the walls. The at least one slot 118 can be on both the first side wall 114 and the second side wall 116. Alternatively, the at least one slot 118 can be formed on just one of the walls. The at least one slot 118 can be positioned anywhere between the front wall 110 and back wall 112 and in some embodiments the at least one slot 118 can be formed on the front wall 110 and back wall 10 112. In yet further embodiments, the at least one slot 118 can be comprised of multiple slots along the same wall.

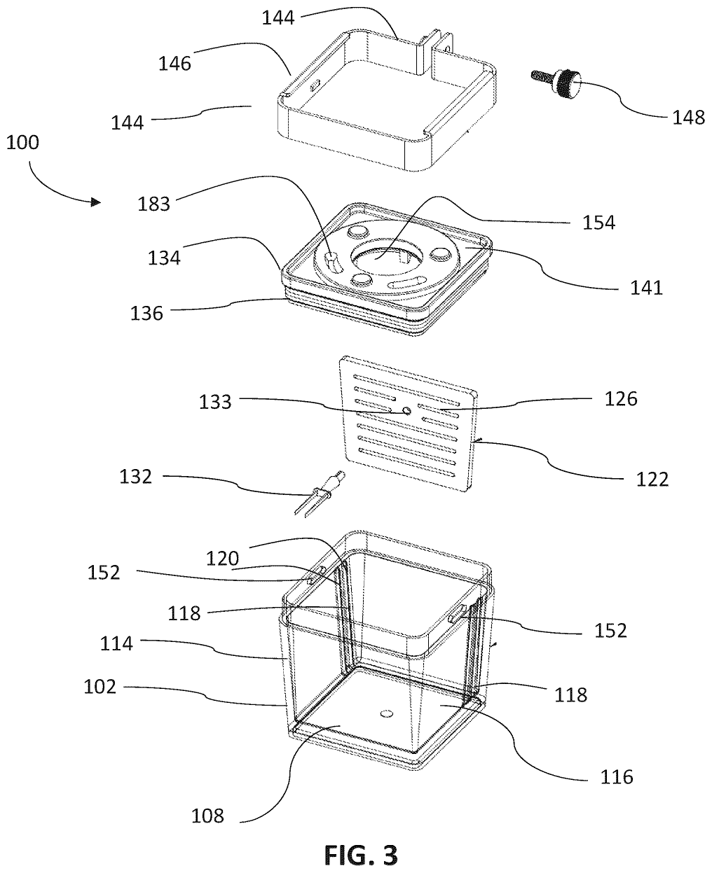

The display device is further comprised of a divider 122. In some embodiments, the divider 122 is configured to fit within the at least one slot 118. The at least one slot 118 provides support for the divider 122 such that the divider remains fixed within the container 102. As shown in FIG. 3, the divider 122 can be inserted into the at least one slot 118 from above. In other embodiments, the divider 122 can be configured to fixedly fit within the container 102 without the at least one slot 118 by being sized to create a friction fit between two opposing walls of the container 102. The divider 122 divides the cavity 114 into a front section 128 and a back section 130.

The divider 122 further defines at least one divider aperture 126 on the divider 122. The at least one divider aperture 126 can be slot-shaped, circular, or any other shape. The at least one divider aperture 126 can comprise a plurality of divider apertures 126 and can be arranged to form a pattern or shape. In some embodiments, the divider 122 can be configured to display branding 124 as shown in FIG. 1B. The branding 124 can depict a logo, name or trademark of a business, present information relating to the sample 104 being displayed, a QR-code, or provide any other sort of information that would otherwise be desirable at point of sale. The branding 124 can be positioned anywhere on the divider 122. In some embodiments, the divider apertures can be incorporated into or otherwise help define the branding 124. In some embodiments, the divider 122 can have a mirrored surface, allowing the back of the sample 104 to be viewed. In other embodiments, the divider can be comprised of mostly divider apertures 126 such that the back of the sample 104 can be viewed when looking through the back wall 112.

In an exemplary embodiment, a humidity control element can be placed in the back section 130 created by the divider 122. The divider 122 substantially hides the presence of the humidity control element and holds it in the back section 130 so that the humidity control element cannot touch or obstruct the view of the sample 104. Further, the at least one divider aperture 126 allows humidity levels in the front section 128 to be controlled at a desired humidity level by the humidity control element in the back section 130. Use of a humidity control element such as is described is advantageous at least for keeping the sample 104 fresh for longer. The humidity control element can be comprised of any material that absorbs and/or releases moisture such as, but not limited to, silica gel desiccant and/or humidity control packs such as those available from Boveda.

In another exemplary embodiment, the at least one slot 118 is comprised of at least two slots formed along the same wall of the container 102. In such a configuration, two dividers 122 can be placed adjacent to each other in substantially parallel planes. In this configuration, the humidity control element can be placed between the two dividers 122 and two samples 104 can be displayed in the container 102 while still concealing the humidity control element. Such a display may be useful, for example, on a central table where viewers may see the display from multiple sides.

The display device 100 can further comprise a spear 132 configured to hold the sample 104. Sample 104 can generally comprise a soft, piercable material such as, for example, a cannabis bud. In some embodiments, the spear 132 can be shaped as a spike, barb, or prong to impale and hold the sample 104. In other embodiments, the spear 132 can be spoon shaped or have walls, jaws or otherwise opposed surfaces such that the sample 104 is held without creating a hole in the sample 104. The spear 132 can be configured to attach to the divider 122 in a spear support aperture 133. In other embodiments, the spear 132 can be configured to fit in any of the divider apertures. In this embodiment, multiple spears 132 can be configured at desired locations on the divider 122 such that multiple samples 104 can be displayed in the display device 100 at the same time. Such a configuration would allow for easy comparison between samples 104. Further still, the spear 132 can be generally linear in shape or comprise a bend to position the sample 104 in front of a large divider aperture 126 such that the sample 104 can be seen through the divider aperture 126 when viewed from the back wall 112.

The display device is further comprised of a lid 134 configured to provide an airtight seal to the container 102. A gasket 136 can be used between the lid 134 and container 102 to seal the container. In some embodiments the gasket 136 is attached to the lid and in some embodiments the gasket 136 can be attached to the container 102. The gasket 136 can be configured to provide a face or radial seal between the container 102 and lid 136.

The lid 134 further comprises a lid vent 183. The lid vent 183 is configured to selectively release air, and consequently, a sample scent, from inside the container 102 to allow a user, for example, to smell the sample 104 when air is released, but to keep the sample 104 fresh when the lid vent 183 is closed. The lid vent 183 can be formed by the lid 134 comprising a movable portion 139 and a fixed portion 141. The movable portion 139 can be moved relative to the fixed portion 141 such that air/scent can escape the container 102 when in an open position and the container 102 remains sealed when the movable portion 139 is in a closed position. In some embodiments, the movable portion 139 spins into the open and closed position. In other embodiments, the movable portion 139 can slide, twist, or be removed to switch between open and closed positions. In some embodiments, a second gasket can be used between the movable portion 139 and fixed portion to better provide an airtight seal when the movable portion 139 is in the closed position. In yet further embodiments, the movable portion 139 can have at least one tactile protrusion 162 to manipulate the movable portion 139, while in other embodiments, the movable portion 139 is flat and uses a high friction material to easily manipulate the movable portion 139. In other embodiments, the lid vent 183 can selectively a container defining a cavity, the container comprising a bottom wall, a front wall, a back wall opposing the front wall, a first side wall, and a second side wall opposing the first side wall;
a first divider configured to split the cavity into a front section and a back section;
at least one spear protruding from the first divider into the front section;
a lid; and
a vent configured to selectively provide an airtight seal to the container.

134 can comprise a normally closed valve that opens with a pressure differential. The container or lid can then be compressed to increase the pressure inside the container 102 and force air/scent to leave the container. Alternatively, the lid vent 183 can be comprised of a removable plug or any other configuration to unseal and seal the container 102.

The lid 134 can further comprise a lens 154. The lens 154 can provide magnification of the sample 104 to allow for better viewing. The lens 154 can be easily removable to allow for different magnifications to be used. In some embodiments, the lens 154 can be configured to attach to the outside of the lid 134 or any of the walls of the container 102 such that the lens 154 can be removed by the viewer if desired while maintaining an airtight seal around the sample 104. In other embodiments, the lid 134 or container walls can be configured to define a lid aperture to receive the lens 154. The lens 154 can fit within the lid aperture by a friction fit, for example. In some embodiments, the lens 154 can fit within the lid aperture and be easily manipulated to create an opening. In such an embodiment, the lens 154, can then also act as the vent 183 to selectively allow air to escape the container 102.

The lid 134 can be attached to the container 102 by a locking strap 144. The locking strap 144 fits around the lid 134 and container 102. The locking strap 144 can be comprised of at least one locking strap indent 146 configured to align and fit in at least one container slot 152. Further, the locking strap 144 can have a screw receiving portion 145. The screw receiving portion receives a screw 148. The screw 148 is inserted through the screw receiving portion 145 of the locking strap 144 and a nut 150 is attached to the screw 148. The nut 150 and screw 148 apply compression to the screw receiving portion 145 to tighten the locking strap 144. When the locking strap 144 is tightened, the locking strap indent 146 fits in the container slot 152 and the locking strap 144 and lid 134 are secured to the container 102 such that they can only be removed by loosening the screw 148 and nut 150. In other embodiments, the screw receiving portion 145 can be threaded such that a nut 150 is not needed. In other embodiments, the lid 134 can attach to the container by hinges, threads, or compression fit. In yet further embodiments, the lid 134 can be attached to the container by sliding into a groove on the container or by use of buckles or elastic configured to attach the lid 134 to the walls of the container 102.

In some embodiments, the lid 134 can also contain a battery and lighting element, such as at least one LED light. The battery can provide power to the lighting element which is configured to provide light on the sample 104 from above. The lighting element can be configured to provide different colors and intensities of light. Such a feature may be desirable to provide better lighting for inspecting the sample 104 in the display device 100. In addition, the lighting may be chosen to provide a better aesthetic or visual effect. This visual effect could be matched to fit with the environment outside the display device. The visual effect could also provide a desirable aesthetic to the divider 122. For example, the lighting element could provide a blacklight and the divider 122 could utilize colors that have a glowing appearance under such blacklight. In this way, for example, more attention may be drawn to the branding 124 if the user is interested in advertising a company or brand. In some embodiments the light can be configured to automatically change between settings to create a dynamic visual effect. In another embodiment, the lighting element and battery could be contained in a bottom section, behind the divider 122 or underneath the bottom wall 108 to provide a lighting effect through the divider apertures 126/bottom wall 108 while concealing the battery and lighting element from sight.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A display device comprising:
a container defining a cavity, the container comprising a bottom wall, a front wall, a back wall opposing the front wall, a first side wall, and a second side wall opposing the first side wall;
a first divider configured to split the cavity into a front section and a back section;
at least one spear protruding from the first divider into the front section;
a lid; and
a vent configured to selectively provide an airtight seal to the container.

2. The display device of claim 1, wherein the container further comprises:
at least one slot on one or both of the first and second side walls and the first divider is configured to be supported by the at least one slot.

3. The display device of claim 1, wherein the lid further comprises:
a magnifying lens.

4. The display device of claim 1, wherein the divider further comprises:
one or more divider apertures, the divider apertures configured to support the at least one spear in multiple locations on the divider.

5. The display device of claim 1, wherein the lid further comprises:
a lighting element.

6. The display device of claim 1, wherein at least one of the front wall, first side wall, and second side wall further comprise:
a magnifying lens.

7. The display device of claim 1, wherein the display device further comprises:
a second divider in the cavity, the second divider configured to be substantially parallel to the first divider such that a space is defined between the first divider and second divider.

8. The display device of claim 7, wherein the at least one spear comprises:
at least one spear protruding from both the first divider and second divider.

9. The display device of claim 1, wherein the vent is selectively opened by manipulating a moving portion.

10. The display device of claim 9, wherein the moving portion rotates.

11. The display device of claim 1, wherein the at least one spear comprises:
at least two prongs.

12. A method for visually displaying an aromatic product comprising:
placing an aromatic product in a container defining a cavity, the cavity being defined by a bottom wall, a front wall, a back wall opposing the front wall, a first side wall, and a second side wall opposing the first side wall;
placing a divider in the container to split the cavity into a first section and a second section;
attaching at least one spear to the divider;
retaining the aromatic product with the at least one spear and covering the container with a lid to enclose the cavity and create an air-tight seal between the lid and the cover.

13. The method of claim 12, wherein the divider comprises at least one divider aperture and wherein the method further comprises:
placing a humidity control element in the second section, whereby the at least one divider aperture allows for a desired humidity level in the first and second section.

14. The method of claim 12, wherein the divider comprises a plurality of divider apertures and wherein the method further comprises:
arranging the plurality of divider apertures to define a desired pattern selected from one or more of a shape, logo, name or trademark.

15. The method of claim 12, wherein at least one of the front wall, back wall, first side wall, second side wall and the lid comprises a vent, the method further comprising:
opening the vent to allow a scent from the aromatic product to escape the cavity.

16. The method of claim 15, wherein the step of opening the vent comprises:
rotating the vent between a closed position and an open position.

17. The method of claim 12, further comprising:
locking the lid to the container with a locking strap.

18. The method of claim 12, further comprising:
placing a second divider in the container to split the cavity into the first section, the second and a third section.
